(19) United States
(12) Patent Application Publication
(10) Pub. No.: US 2010/0084827 A1
(43) Pub. Date: Apr. 8, 2010

(54) SELF-RETAINING SEAL FOR UNDERCUT GROOVE

(76) Inventor: Darron G. Peddle, Millersburg, IN (US)

Correspondence Address: JOHN MOLNAR JR., PARKER-HANNIFIN CORPORATION, 6035 PARKLAND BOULEVARD, CLEVELAND, OH, 44124-4141, US

(21) Appl. No.: 12/564,318

(22) Filed: Sep. 22, 2009

Related U.S. Application Data
(60) Provisional application No. 61/103,611, filed on Oct. 8, 2008.

(51) Int. Cl. F16J 15/02

(52) U.S. Cl. 277/644

(57) ABSTRACT

Seal ring or other construction for providing a fluid seal intermediate a pair of opposing surfaces. The seal includes a body formed of a resilient material which is configured as having a series of projections which extend radially outwardly from lateral surfaces thereof such that the seal is self-retaining in a dovetail or other undercut groove.

### CROSS-REFERENCE TO RELATED CASES

The present application claims the benefit of the filing date of U.S. Provisional Application Ser. No. 61/103,611, filed Oct. 8, 2008, the disclosure of which is expressly incorporated herein by reference.

### BACKGROUND OF THE INVENTION

The present invention relates broadly to a press-in-place-type seal construction for providing a face or other fluid seal between a pair of opposed, mating parts or structures, and more particularly to such a construction for dovetail or other undercut grooves which is self-retaining in the groove.

Press-in-place seals are used in a variety of face sealing applications such as for covers, manifolds, and doors, and in many industries including semiconductor fabrication. These seals are design for being pressed into a groove, which may be straight-walled or undercut, i.e., dovetailed, that is molded, machined, or otherwise formed in the face of a metal or plastic component. Seals of such type are disclosed, for example, in U.S. Pat. Nos. 7,306,237; 6,328,316; 6,523,833; and 5,482,297, and are sold commercially by the Engineered Seals Division of Parker-Hannifin Corp., Syracuse, Ind., under the tradenames “Diamond Seal” and “H-Seal.”

Dovetail and other undercut grooves are designed with a narrower opening width in order to “pinch” the seal into position and to retain the seal in place. While effective at retaining a seal, this method requires more assembly care and effort to prevent elongation or twisting of the seal.

When a seal is elongated during assembly, it must be removed and reinstalled. Reinstallation may be complicated by permanent stretch introduced during the initial installation. Ultimately, the seal may have to be replaced to achieve acceptable performance.

Twisted seal orientations can adversely affect performance, particularly if the twist causes the parting line seam to cross the sealing interface. When this occurs, some leakage may occur in low pressure and vacuum applications.

It therefore is believed that improvements in press-in-place seal constructions for undercut grooves would be well-received in the field

### BROAD STATEMENT OF THE INVENTION

The present invention is directed to a press-in-place seal construction which is self-retaining in a dovetail or other undercut groove. The seal, which may be shaped in the form of a resilient material such as a rubber or other elastomer and which may be shaped as a ring or other closed or open geometry, is configured as having a series of projections which extend radially outwardly from lateral surfaces of the seal.

Such projections, which may be hemispherical, cylindrical, or disc-shaped bumps, or other such lobes or features extend below the undercut of the groove to retain the seal therein without affecting the proper orientation of the seal. Rather, the features help to ensure the proper orientation of the seal in the groove by reducing or eliminating the potential of the seal to twist or otherwise roll during installation. This helps to speed installation and reduces downtime, rework, and, as there is less overall interference between the seal and the grooves, to reduce the potential for particle generation.

The projections, moreover, in being able to positively contact the groove walls can aid in retaining the seal in grooves which have been eroded or otherwise worn. The seal profile of the invention also allows the seal to be designed with no parting line along its sealing surfaces. These and other advantages will be readily apparent to those skilled in the art based upon the disclosure contained herein.

The present invention, accordingly, comprises the construction, combination of elements, and/or arrangement of parts and steps which are exemplified in the detailed disclosure to follow.

### BRIEF DESCRIPTION OF THE DRAWINGS

For a fuller understanding of the nature and objects of the invention, reference should be had to the following detailed description taken in connection with the accompanying drawings wherein:

FIG. 1 is a perspective view of an illustrative embodiment of a self-retaining seal according to the present invention;

FIG. 2 is a fragmentary perspective cross-sectional view of the seal of FIG. 1 taken through line 2-2 of FIG. 1;

FIG. 3 is a cross-sectional installation view showing the seal of FIG. 1 as pressed-in-place within a representative undercut groove; and

FIG. 4 is a cross-sectional installation view showing an alternative embodiment of the seal of FIG. 1 as pressed-in-place within a worn undercut groove.

The drawings will be described further in connection with the following Detailed Description of the Invention.

### DETAILED DESCRIPTION OF THE INVENTION

Certain terminology may be employed in the following description for convenience rather than for any limiting purpose. For example, the terms “forward” and “rearward,” “front” and “rear,” “right” and “left,” “upper” and “lower,” and “top” and “bottom” designate directions in the drawings to which reference is made, with the terms “inward,” “inner,” “interior,” or “inboard” and “outward,” “outer,” “exterior,” or “outboard” referring, respectively, to directions toward and away from the center of the referenced element, the terms “radial” or “horizontal” and “axial” or “vertical” referring, respectively, to directions or planes which are perpendicular, in the case of radial or horizontal, or parallel, in the case of axial or vertical, to the longitudinal central axis of the referenced element, and the terms “downstream” and “upstream” referring, respectively, to directions in and opposite that of fluid flow. Terminology of similar import other than the words specifically mentioned above likewise is to be considered as being used for purposes of convenience rather than in any limiting sense.

In the figures, elements having an alphanumeric designation may be referenced herein collectively or in the alternative, as will be apparent from context, by the numeric portion of the designation only. Further, the constituent parts of various elements in the figures may be designated with separate reference numerals which shall be understood to refer to that constituent part of the element and not the element as a whole. General references, along with references to spaces, surfaces, dimensions, and extents, may be designated with arrows. Angles may be designated as “included” as measured relative to surfaces or axes of an element and as defining a space bounded internally within such element therebetween, or otherwise without such designation as being measured relative to surfaces or axes of an element and as defining a space bounded externally by or outside of such element therebetween. Generally, the measures of the angles stated are as determined relative to a common axis, which axis may be transposed in the figures for purposes of convenience in projecting the vertex of an angle defined between the axis and a surface which otherwise does not extend to the axis. The term “axis” may refer to a line or to a transverse plane through such line as will be apparent from context.

For purposes of illustration, the precepts of the self-retaining seal construction of the invention herein involved are described principally in connection with its configuration as ring having a generally circular circumference or other closed geometry. Such seals are used for a variety of fluid, i.e., liquid, gas, particulate solids, and/or plasmas, face-sealing applications. In view of the discourse to follow, however, it will be appreciated that aspects of the present invention may find utility in other seal configurations having circumferences or perimeters of other regular or irregular closed geometries, or in linear or rectilinear, or curvilinear or otherwise actuate open geometries such as strips or other lengths. Use within those such other shapes and lengths therefore should be considered to be expressly within the scope of the present invention.

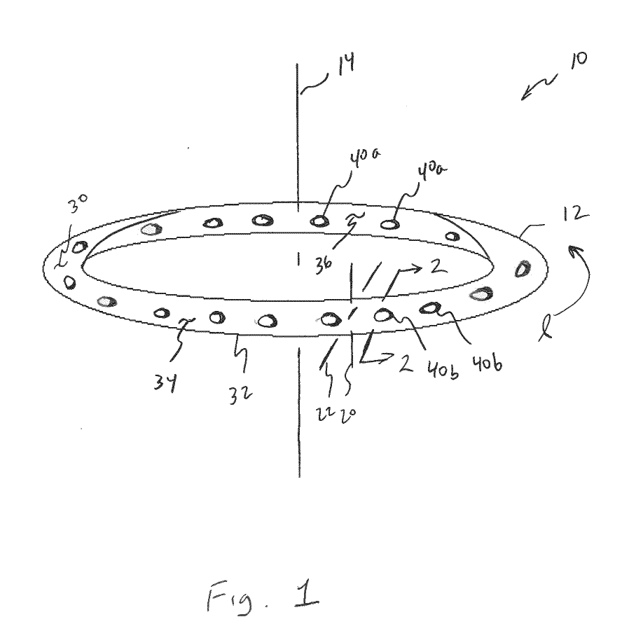

Referring then to the figures wherein corresponding reference characters are used to designate corresponding elements throughout the several views with equivalent elements being referenced with prime or sequential alphanumeric designations, a representative seal according to the present invention is shown generally as a seal ring 10 in the perspective view of FIG. 1. In the unstressed or free state of seal ring 10 which is depicted in FIG. 1, seal ring 10 has a body, 12, which extends around a longitudinal axis, 14, in defining a generally circular circumference. Body 12 of seal ring 10 may be conventionally molded, extruded and cut, or otherwise formed of an elastomeric material which specifically may be selected for low or high temperature performance, flexibility, or otherwise for compatibility with the fluid being handled. Suitable materials, which may be filled, for example, with glass or carbon black, or which may be unfilled, include natural rubbers such as Hevea and thermoplastic, i.e., melt-processible, or thermosetting, i.e., vulcanizable, synthetic rubbers such as: fluoro- or perfluoroelastomers, chlorosulfonate, polybutadiene, butyl, neoprene, nitrile, polyisoprene, buna-N, copolymer rubbers such as ethylene-propylene (EPR), ethylene-propylene-diene monomer (EPDM), acrylonitrile-butadiene (NBR or HNBR) and styrene-butadiene (SBR), and blends such as ethylene or propylene-EPDM, EPR, or NBR. The term “synthetic rubbers” also should be understood to encompass materials which alternatively may be classified broadly as thermoplastic or thermosetting elastomers such as polyurethanes, silicones, fluorosilicones, styrene-isoprene-styrene (SIS), and styrene-butadiene-styrene (SBS), as well as other polymers which exhibit rubber-like properties such as plasticized nylons, polyolefins, polyesters, ethylene vinyl acetates, fluoropolymers, and polyvinyl chloride. As used herein, the term “elastomeric” is ascribed its conventional meaning of exhibiting rubber-like properties of compliancy, resiliency or compression deflection, low compression set, flexibility, and an ability to recover after deformation, i.e., stress relaxation.

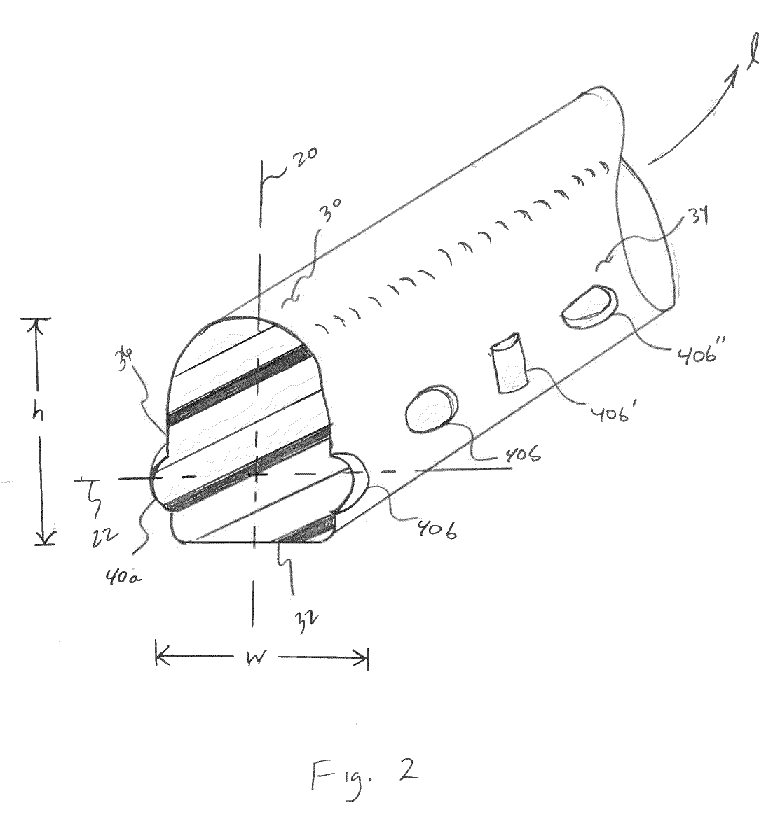

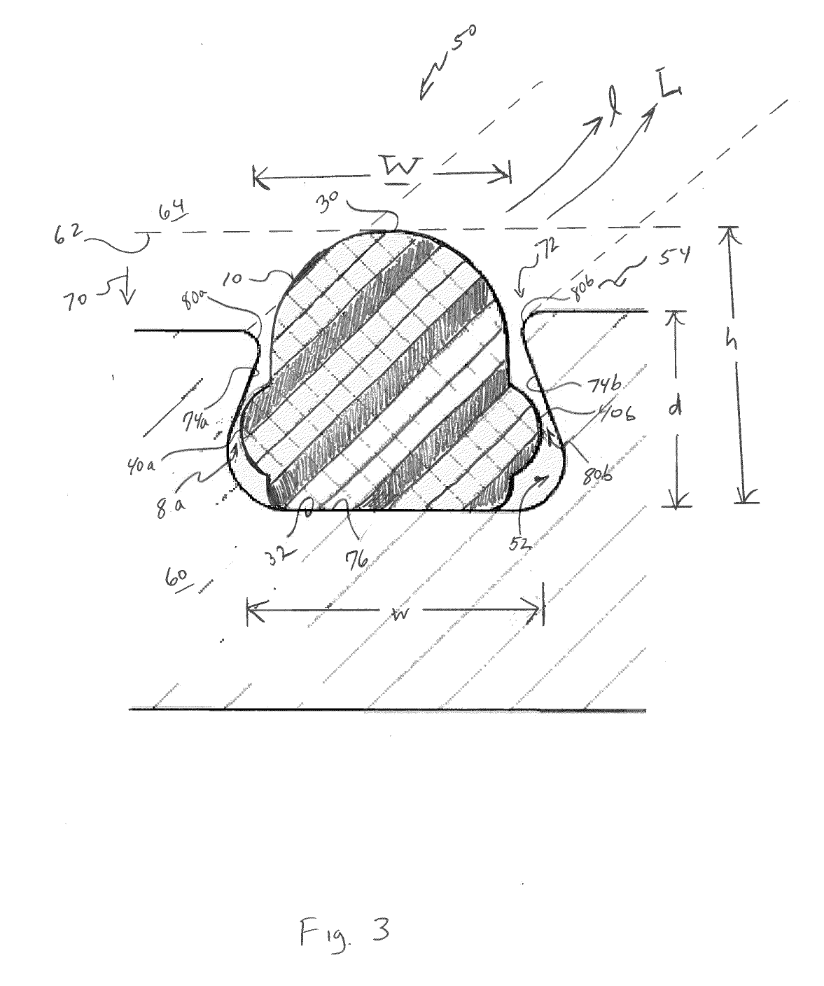

As may be seen best with additional reference to the perspective cross-sectional view of FIG. 2, body 12 may have a generally semi-circular, D-shaped profile which may be centered relative to a vertical seal axis, 20, disposed generally parallel to longitudinal axis 14, and a horizontal seal axis, 22, disposed orthogonally to the vertical axis 20. Although the profile of seal body 12 is shown in FIG. 3 to be generally D-shaped, such profile alternatively may be polygonal, i.e., square, rectangular, or trapezoidal. Depending on such cross-sectional shape and otherwise on the geometry of seal ring 10, seal ring 10 may have a generally curved, i.e., rounded, top surface, 30, and an opposing generally planar base surface, 32, as well as a first lateral surface, 34, which may be the inner diameter of ring 10, and an opposing second lateral surface, 36, which may be the outer diameter face of ring 10. As seal ring 10 may be received within a groove in a face sealing application and compressed between intermediate relatively movable, i.e., dynamic, or fixed, i.e., static, mating machine parts, hardware, or other surfaces, the top and base surfaces 30 and 32 may function as upper and lower sealing surfaces, with the height, referenced at “h,” of seal ring 10 being defined therebetween.

With continuing reference to FIGS. 1 and 2, each of the lateral surfaces 34 and 36 extends between the top and base surfaces 30 and 32, and is formed as having a series of projections, commonly referenced at 40a for first lateral surface 34 and at 40b for second lateral surface 36, along the circumference or other lengthwise extent, designated by the direction referenced at “λ,” of the seal ring 10. As shown, each of the projections 40a may be aligned in radial registration with a corresponding one of the projections 40b, although the projections 40a and 40a alternatively may be staggered. As may be seen best in FIG. 2, each of the projections 40a and 40b extend radially outwardly from a corresponding one of the lateral surface 34 or 36 and together with a correspond one of the other projections 40a or 40b define the widthwise extent, referenced at “w” in FIG. 2 of seal 10 along the horizontal seal axis 22. Although the projections 40 are shown to be general hemispherically-shaped or otherwise rounded, the projections alternatively may be generally cylindrically-shaped, as shown at 40b′ in FIG. 2, or as generally disc-shaped, as shown at 40b″ in FIG. 2, or as otherwise lobe-shaped.

Turning next to FIG. 3, a representative face-sealing assembly is shown generally at 50 with seal 10 being installed within a dovetail groove, 52, provided in an radial surface, 54, of a first member, 60, for compression between that surface and a mating, faying, or otherwise interfacing radial surface, shown in phantom at 62, of an opposing second member, referenced in phantom at 64. Members 60 and 64, each of which may be metal or plastic, a metal or plastic alloy or blend, or a composite or combination thereof, may together comprise a cover, manifold, or door assembly such as may be found on tools for semiconductor fabrication. In service, seal ring 10 may be compressed, i.e., deflected, by about 10-30% in the direction referenced at 70 intermediate the surfaces 54 and 62 to provide a fluid-tight seal therebetween.

Groove 52 may be machined, molded, or otherwise formed in the surface 54 as having a opening, referenced at 72, a first and a second side wall, 74a-b, and a bottom wall, 76, axially spaced-apart from opening 72, and extending radially between side walls 74a-b. As extending from bottom wall 76 to opening 72, at least one or, as shown, each of side walls 74a-b is inwardly angled or otherwise extends convergently towards the other to define the dovetail or other undercut shape of grove 52. The corresponding edges, 80a-b of walls 74a-b, which may be rounded, chamfered, or otherwise radiused, define the width, referenced at “W,” of opening 72, with the groove also having a depth, referenced at “d.”

As received within the groove 52 with the length λ (FIG. 2) of seal ring 10 extending along the length, designed in phantom in the direction referenced at “L,” of groove 52, and with the widthwise extent w of seal ring 10 extending across the groove 52, seal ring base surface 32 rests or otherwise is supported on groove bottom wall 76 with the projections 40 being disposed below the groove opening 72. For the seal ring top surface 30 to be contactible by second member surface 62, ring 10 may be sized such that the height h thereof extends axially beyond the groove depth d and past first member radial surface 54. With the widthwise extent w of seal ring 10 being sized to be marginally larger that the width W of opening 72 and as defining a clearance, referenced at 80a-b, between the projections 40a-b and a corresponding one of the side walls 74a-b, once-press-fit into place, seal ring 10 may be both self-retaining and self-aligning within groove 52.

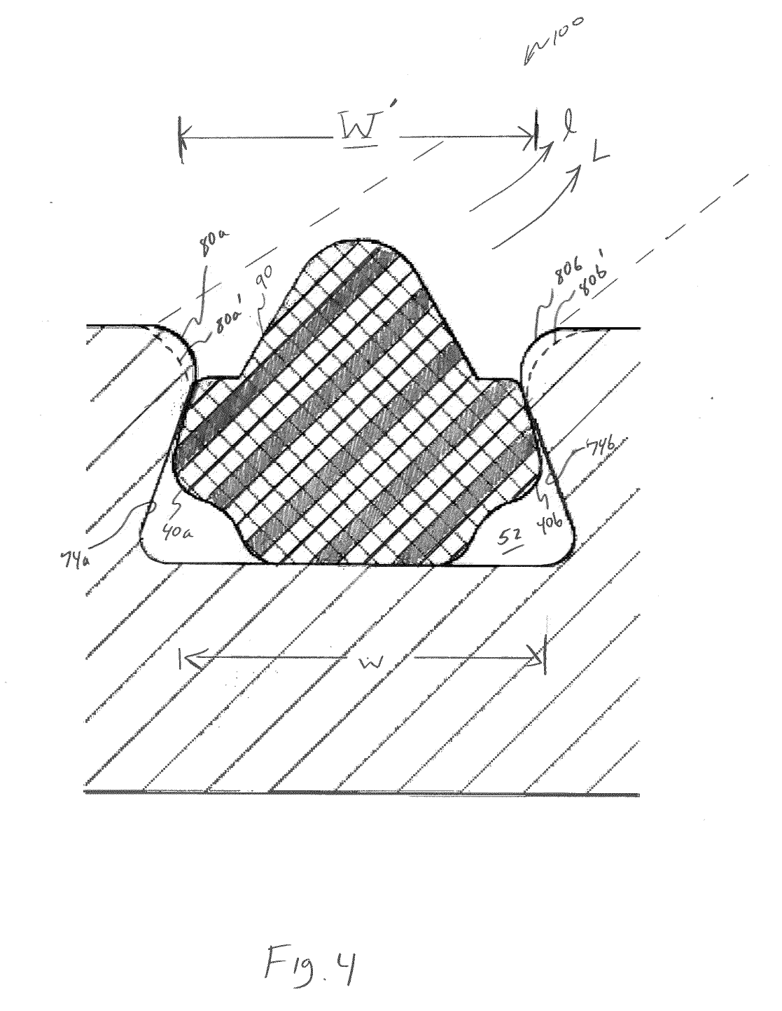

An alternative profile for seal ring 10 is shown generally at 90 in the assembly 100 of FIG. 4. In such profile for ring 90, which profile otherwise may have, for example, a generally frustoconical shape, each of projections 40a-b may be extended laterally outwardly such that clearances 80a-b (FIG. 3) are eliminated and the projections 40a-b thus may contact a corresponding groove side wall 74a-b in an interference-fit or other such engagement. In this way, ring 90 may be made to be self-retaining within grooves 52 having edges 80a-b that have been eroded or otherwise worn, as shown in phantom at 80a′-b′, such as to an extent that the width, now referenced at W′, of groove opening 72 may be marginally larger than the widthwise extent of seal ring 90.

Thus, a unique seal construction for commercial, industrial, military, or other applications is described which is both self-aligning and self-retaining in dovetail or other undercut grooves.

As it is anticipated that certain changes may be made in the present invention without departing from the precepts herein involved, it is intended that all matter contained in the foregoing description shall be interpreted in as illustrative rather than in a limiting sense. All references including any priority documents cited herein are expressly incorporated by reference.

What is claimed is:

1. An assembly comprising:
a member having a radial surface with an annular undercut groove formed therein, the groove having an opening of a given width, a first and a second side wall, and a bottom wall axially spaced-apart from the opening and extending radially between the side walls, at least one of the side walls extending towards the other between the bottom wall and the opening; and
an annular seal formed of a resilient material installed in the groove as having a lengthwise extent along the groove and a widthwise extent across the groove, the seal having a base surface supported on the groove bottom wall and an opposing top surface, and the seal having a first lateral surface disposed opposite the groove first side wall, and a second lateral surface disposed opposite the groove second side wall, each of the lateral surfaces extending intermediated the top and base surfaces and being formed as having a series of projections along the lengthwise extent of the seal, the projections being disposed below the groove opening and extending radially outwardly from the corresponding lateral surface of the seal opposite a corresponding one of the groove lateral surfaces.

2. The assembly of claim 1 wherein the seal projections are generally hemispherically shaped.

3. The assembly of claim 1 wherein the seal projections are generally cylindrically shaped.

4. The assembly of claim 1 wherein the seal projections are generally disc-shaped.

5. The assembly of claim 1 wherein the widthwise extent of the seal defines a clearance between the groove side walls.

6. The assembly of claim 1 wherein each of the seal projections contacts a corresponding one of the groove side walls.

7. The assembly of claim 1 wherein the body of the seal is formed of a resilient material.

8. The assembly of claim 7 wherein the resilient material is an elastomer.

9. The assembly of claim 1 wherein the seal top surface has a height extending axially beyond the radial surface of the member.

10. The assembly of claim 1 wherein the seal base surface is generally planar.

11. The assembly of claim 1 wherein the seal top surface is generally curved.

12. The sealing assembly of claim 1 wherein the lengthwise extent of the seal body defines a closed geometry.

13. The sealing assembly of claim 12 wherein the closed geometry is a ring.

14. The sealing assembly of claim 1 wherein the projections on opposite lateral surfaces of the seal define a widthwise extent of the seal larger than width of the groove opening.
